(19) United States
(12) Patent Application Publication
(10) Pub. No.: US 2006/0093943 A1
(43) Pub. Date: May 4, 2006

(54) Magenta color toner, toner cartridge, and process cartridge and image forming apparatus using the magenta color toner

(76) Inventors: Hyo Shu, Mishima-shi (JP); Mitsuo Aoki, Numazu-shi (JP); Minoru Masuda, Numazu-shi (JP); Kumi Hasegawa, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/258,872

(22) Filed: Oct. 27, 2005

(30) Foreign Application Priority Data
Nov. 4, 2004 (JP) 2004-320116

(51) Int. Cl. G03G 9/08

(52) U.S. Cl. 430/108.23; 430/109.4; 430/108.4; 430/108.6; 430/108.3

(57) ABSTRACT

A magenta color toner including toner particles including a binder resin including a polyester resin including an inorganic tin (II) compound; a colorant having one of naphthol compounds having one of specific formulae. A process cartridge in which includes a photoreceptor bearing an electrostatic latent image; and a developing device configured to develop the latent image with a developer including the magenta color toner to from a toner image on the photo receptor are unitized. An image forming apparatus including a photoreceptor; a charger configured to charge the photoreceptor; a light irradiator configured to irradiate the photoreceptor with imagewise light to form an electrostatic latent image; a developing device configured to develop the latent image with a developer including the magenta color toner to from a toner image on the photoreceptor; and a transfer device configured to transfer the toner image onto a receiving material.

### BACKGROUND OF THE INVENTION

1. Field of the Invention

The present invention relates to a magenta color toner for use in developing an electrostatic latent image formed by an image forming method such as electrophotography, electrostatic recording methods and electrostatic printing methods. In addition, the present invention also relates to a toner cartridge containing the magenta color toner, and a process cartridge and an image forming apparatus using the magenta color toner.

2. Discussion of the Background

An electrostatic latent image formed on an image bearing member, for example, by electrophotography, electrostatic recording, electroprinting or the like method is developed with a developer to form a visible image (i.e., a toner image) on the image bearing member (developing process). The toner image is then transferred onto a receiving material such as receiving paper optionally via an intermediate transfer medium (transfer process). The toner image on the receiving material is then fixed on the receiving material (fixing process).

In electrophotography, an electrostatic latent image is formed by uniformly charging a photoreceptor serving as an image bearing member utilizing discharging, and then irradiating the charged photoreceptor with imagewise light.

Among various fixing methods, heat roller fixing methods in which a receiving material bearing a toner image thereon is heated and fed by a pair of rollers including at least a heat roller have been widely used because of having good energy efficiency.

Recently a need exists for an electrophotographic image forming apparatus in which energy consumption is reduced as much as possible to save energy. Therefore, it is desired to develop fixing members (such as heat rollers) having a low heat capacity and a toner having a good low temperature fixability.

In general, a toner having a good low temperature fixability has such drawbacks as to have a narrow fixable temperature range (i.e., a poor hot offset resistance) and a poor high temperature preservability. Particularly, a magenta color toner having a good low temperature fixability has such additional drawbacks as to have a low fixability and cause a scattering problem in that toner particles are scattered in a developing device, resulting in contamination of the image forming members in the image forming apparatus.

In attempting to remedy these drawbacks, published unexamined Japanese patent application No. (hereinafter JP-A) 2001-305788 discloses a toner including two or more binder resins having different molecular weights, wherein the lower molecular weight binder resin improves the low temperature fixability of the toner and the higher molecular weight binder resin improves the hot offset resistance and high temperature preservability of the toner.

Among various toner binder resins, polyester resins have been typically used to improve the low temperature fixability of the toner. When polyester resins are prepared, catalysts such as organic tin (IV) compounds (e.g., dibutyl tin oxide), titanium compounds (e.g., tetra-n-butyl titanate), germanium compounds (e.g., germanium oxide) and manganese compounds (e.g., manganese oxide) have been used. For example, it is described in JP-A 2001-305788 to use a polyester resin which is prepared using an organic tin (IV) compound as a catalyst.

JP-A 2003-231744 discloses a toner including a polyester resin which is prepared using an inorganic tin (II) compound as a catalyst. It is described therein that the resultant toner has a good charge rising property. However, JP-A 2003-231744 is silent on the low temperature fixability, hot offset resistance and high temperature preservability of the toner.

Because of these reasons, a need exists for a toner (particularly a magenta color toner) which has a good combination of low temperature fixability, hot offset resistance and high temperature preservability while having an improved safety and which does not cause the scattering problem.

### SUMMARY OF THE INVENTION

The magenta color toner of the present invention includes toner particles including at least a binder resin which includes a polyester resin prepared using an inorganic tin (II) compound as a catalyst and including the inorganic tin compound, and a colorant including a naphthol compound having the following formula (1), (2) or (3):

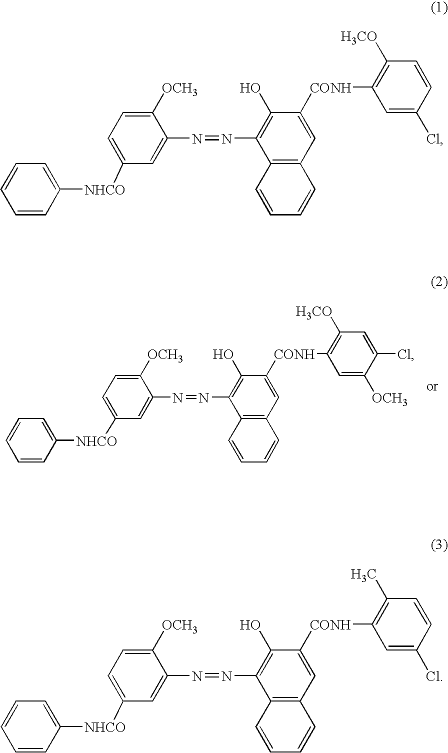

It is preferable that the magenta color toner further includes a wax and preferably a carnauba wax. The wax is preferably included in an amount of from 3 to 8 parts by weight per 100 parts by weight of toner particles. The inorganic tin compound is preferably tin (II) dioctanate, tin(II) distearate or tin (II) oxide. The inorganic tin compound is preferably included in an amount of from 0.001 to 5 parts by weight per 100 parts by weight of the polyester resin. The polyester resin preferably includes a unit obtained from a propyleneoxide adduct of bisphenol A and a unit obtained from terephthalic acid.

It is preferable that the toner further includes an external additive which is present at least on the surface of the toner particles. The external additive is preferably a particulate inorganic material and more preferably a combination of a hydrophobized silica and a hydrophobized titanium oxide.

As another aspect of the present invention, a toner cartridge containing the above-mentioned magenta color toner is provided.

As yet another aspect of the present invention, a process cartridge is provided which includes at least a photoreceptor bearing an electrostatic latent image and a developing device configured to develop the electrostatic latent image with a developer including the magenta toner mentioned above to form a toner image on the surface of the photoreceptor, wherein the process cartridge is detachably attached to an image forming apparatus as a unit.

As a further aspect of the present invention an image forming apparatus is provided which includes:

a photoreceptor;

a charger configured to charge a surface of the photoreceptor;

a light irradiator configured to irradiate the charged photoreceptor with imagewise light to form an electrostatic latent image on the surface of the photoreceptor;

a developing device configured to develop the electrostatic latent image with a developer including the magenta toner mentioned above to form a toner image on the surface of the photoreceptor; and

a transferring device configured to transfer the toner image onto a receiving material optionally via an intermediate transfer medium.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an electrophotographic image forming apparatus of the present invention; and

FIG. 2 is a schematic view illustrating an example of the process cartridge of the present invention.

### DETAILED DESCRIPTION OF THE INVENTION

As a result of the present inventors' study, it is found that by using a combination of a polyester resin which is prepared using an inorganic tin (II) compound as a catalyst and includes the inorganic tin compound, and a magenta colorant having a specific formula, the resultant toner has a good fixing properties and which does not cause the scattering problem. This discovery leads to the present invention.

Then the present invention will be explained in detail. The present invention is based on a discovery in that using an inorganic tin (II) compound (hereinafter sometimes referred to as inorganic tin compound) is very effective in improving the low temperature fixability of a toner. In this application, the inorganic tin compounds are defined as tin compounds having no Sn—C bond.

The mechanism why a toner including an inorganic tin compound has good fixing properties is not known yet, but is considered to be as follows. A toner including an inorganic tin compound tends to be agglomerated due to the Sn—X bond (X represents an atom such as oxygen atom and halogen atoms) of the tin compound. Therefore, when the toner is fixed upon application of heat, the toner is melted without scattering, resulting in formation of a toner image having good fixability. In addition, polyester resins prepared using an inorganic tin compound as a catalyst have a molecular weight distribution broader than that of polyester resins prepared using an organic tin compound as a catalyst. Namely, polyester resins prepared using an inorganic tin compound include low molecular weight components in an amount larger than that in cases where polyester resins prepared using an organic tin compound are used. Therefore, a toner including an inorganic tin compound and a polyester resin prepared using the inorganic tin compound has better low temperature fixability than a toner including a polyester resin prepared using an organic tin compound as a catalyst.

In addition, conventional magenta color toners typically include a quinacridone pigment as a magenta colorant. It is well known that such magenta toners cause the scattering problem and have a poor fixability. In the present invention, the low temperature fixability of the toner can be improved by including an inorganic tin compound therein. In addition, by including a naphthol pigment having one of specific formulae (1) to (3) in the toner, the low temperature fixability and the scattering resistance of the toner can be dramatically improved.

With respect to the colorant, PIGMENT RED 269-has formula (1), PIGMENT RED 146 has formula (2) and PIGMENT RED 147 has formula (3). Among these colorants, PIGMENT RED 269 having formula (1) is more preferably used as the colorant of the toner of the present invention.

The content of such a naphthol compound in the toner is preferably from 2 to 10 parts by weight per 100 parts by weight of toner particles. When the content is too low, the toner cannot produce images having high image density. When the content is too high, the toner tends to produce grainy images (i.e., microscopically uneven images). When such a naphthol compound is not included in a toner, the toner causes the toner scattering problem.

When the toner of the present invention includes a wax, the fixability of the toner (particularly the hot offset resistance) can be dramatically improved. The present inventors discover that a wax dispersed in a polyester resin including an inorganic tin compound has an average particle diameter smaller than that of the wax dispersed in a polyester resin including an organic tin compound when the particle diameter is measured with a transmission electron microscope (TEM). Therefore, the toner of the present invention has good releasability from a fixing roller in the fixing process. Since a wax, which has a lower molecular weight than a binder resin, is well dispersed in toner particles, the low temperature fixability of the toner can be further improved.

The content of a wax in the toner of the present invention is preferably from 3 to 8 parts by weight per 100 parts by weight of toner particles. When the content is too low, the toner does not cause an offset problem when used for fixing devices in which an oil is applied to a fixing roller to improve the releasability of the fixing roller from toner images. However, when the toner is used for oil-less fixing devices, there is a case where the tone causes the hot offset problem. When the wax content is not lower than 3 parts by weight, the toner can be used for such oil-less fixing devices. In contrast, when the wax content is too high, the high temperature preservability of the toner deteriorates and a filming problem in that a wax film is formed on the photoreceptor used occurs. In addition, a so-called spent carrier problem in that a wax film is formed on carrier particles, resulting in deterioration of charging ability of the carrier particles occurs, thereby causing the toner scattering problem. The wax content is preferably from 4 to 6 parts by weight.

Then polyester resins prepared using an inorganic tin (II) compound as a catalyst will be explained in detail. By using an inorganic tin (II) compound as a catalyst, the resultant polyester resin includes the inorganic tin (II) compound therein.

As mentioned above, in the present application inorganic tin (II) compounds are defined as tin compounds having no Sn—C bond. Specific examples of such inorganic tin compounds include tin compounds having a carboxyl group such as tin (II) oxalate (i.e., stannous oxalate),tin (II) diacetate, tin (II) dioctanate, tin (II) dilaurate, tin (II) distearate, and tin (II) dioleate; tin compounds having an alkoxy group such as dioctyloxy tin (II), dilauroxy tin (II), distearoxy tin (II), and dioleyloxy tin (II); tin oxide; halogenated tin (II) compounds such as stannous chloride and stannous bromide, etc. Among these compounds, tin (II) dioctanate, tin (II) distearate and tin oxide are preferably used.

When polyester resins are prepared, polyhydric alcohols having two or more hydroxyl groups and polybasic carboxylic acids having two or more carboxyl groups are used as raw materials (i.e., monomers). In this regard, a small amount of monohydric alcohols and monobasic carboxylic acids can be used to control the molecular weight of the resultant polyester resin and to improve the offset resistance of the toner.

Specific examples of the dihydric alcohols include alkylene (carbon number of from 2 to 4) oxide adducts of bisphenol A such as polyoxypropylene(2.2)-2,2-bis(4-hydroxyphenyl)propane, and polyoxyethylene(2.2)-2,2-bis(4-hydroxyphenyl)propane; ethylene glycol, propylene glycol, neopentyl glycol, 1,4-butane diol, 1,3-butane diol, 1,6-hexane diol, etc. The average molar number of the added alkylene oxide is preferably from 1.5 to 6.

Specific examples of the polyhydric alcohols having three or more carboxyl groups include sorbitol, pentaerythritol, glycerol, trimethylol propane, etc.

Specific examples of the dibasic carboxylic acids include aromatic dicarboxylic acids such as phthalic acid, terephthalic acid, and isophthalic acid; aliphatic dicarboxylic acids such as sebacic acid, fumaric acid, maleic acid, adipic acid, azelaic acid, and dodecenylsuccinic acid; alicyclic dicarboxylic acids such as cyclohexane dicarboxylic acid; and anhydrides of these acids and alkyl (carbon number of from 1 to 3) esters of these acids.

Specific examples of the polybasic carboxylic acids having three or more carboxyl groups include aromatic carboxylic acids such as 1,2,4-benzene tricarboxylic acid (i.e., trimellitic acid), 2,5,7-naphthalene tricarboxylic acid, and pyrromellitic acid; and anhydrides and alkyl (carbon number of from 1 to 3) esters of these acids.

Among these raw materials, secondary polyhydric alcohols and aromatic polybasic acids are preferably used. Secondary polyhydric alcohols mean polyhydric alcohols in which at least one hydroxyl group is connected with a secondary carbon atom. Specific examples thereof include propylene oxide adducts of bisphenol A, propylene glycol, 1,3-butane diol, glycerol, etc. Among these compounds, propylene oxide adducts of bisphenol A are preferably used.

Among the aromatic polybasic carboxylic acids, terephthalic acid, isophthalic acid, phthalic acid and trimellitic acid are preferably used. More preferably, terephthalic acid and trimellitic acid are used.

When either a secondary alcohol compound or an aromatic carboxylic compound is used, the content of the secondary alcohol compound or the aromatic carboxylic compound in the raw materials is preferably from 50 to 100% by mole, and more preferably from 80 to 100% by mole, based on the total moles of the alcohol monomers or the acid monomers. When both a secondary alcohol compound and an aromatic carboxylic compound are used, the content of the secondary alcohol compound and the aromatic carboxylic compound is preferably from 20 to 100% by mole, and more preferably from 50 to 100% by mole, based on the total moles of the raw monomers.

It is preferable to use either a secondary alcohol compound or an aromatic carboxylic compound and it is more preferable to use both a secondary alcohol compound and an aromatic carboxylic compound.

It is even more preferable to use a combination of a propylene oxide adduct of bisphenol A and terephthalic acid because the resultant toner has good charge stability due to the resonance effect of the benzene rings in the compounds. The same effect can be produced when a mixture of a resin prepared using one of the compounds and another resin prepared using another of the compounds is used as the binder resin.

Polyester resins, which can be used for the toner of the present invention, can be prepared, for example, by a method in which one or more of the alcohol components mentioned above and one or more of the carboxylic acids mentioned above are subjected to a condensation polymerization reaction in an inert gas atmosphere at a temperature of from 180 to 250° C., using an inorganic tin (II) compound as a catalyst. This reaction is performed under a reduced pressure, if desired.

The added amount of an inorganic tin (II) compound is preferably from 0.001 to 5 parts by weight, and more preferably from 0.05 to 2 parts by weight, per 100 parts by weight of the monomers used. Namely, the content of an inorganic tin (II) compound in the polyester resin used for the toner is preferably from 0.001 to 5 parts by weight, and more preferably from 0.05 to 2 parts by weight, per 100 parts by weight of the resultant polyester resin.

Polyester resins having a softening point of from 90 to 170° C., and preferably 95 to 150° C., are preferably used as a binder resin for the toner for use in the image forming apparatus of the present invention. Polyester resins having a glass transition temperature (Tg) of from 50 to 130° C., and preferably from 50 to 80° C., are preferably used.

Then the constituents of the toner of the present invention other than polyester resins will be explained.

Binder Resin

The content of a polyester resin serving as a binder resin of the toner of the present invention is preferably from 50 to 100% by weight, more preferably from 80 to 100% by weight, and even more preferably 100% by weight based on the total weight of the binder resin.

Other resins such as addition polymerization resins such as styrene—acrylic resins; epoxy resins, polycarbonate resins, and polyurethane resins can be used in combination with a polyester resin.

When one or more resins other than polyester resins are used in combination with polyester resins, a mixture thereof can be used. However, it is preferable to use a hybrid resin in which two or more resins including a polyester resin are chemically bonded with each other. Namely, it is preferable to use a hybrid resin in which one or more polyester resins prepared using an inorganic tin (II) compound is partially bonded with one or more addition polymerization resin components. Hybrid resins can be prepared by the following methods:
(1) a method in which two or more resins are reacted;
(2) a method in which a resin is reacted with a mixture of monomers for another resin; and
(3) a method in which monomers for two or more resins are reacted.

Among these methods, the method (3) is preferably used.

The binder resin of the toner of the present invention preferably has a softening point of from 90 to 170° C. and more preferably from 95 to 150° C., and a glass transition temperature of from 50 to 130° C. and more preferably from 50 to 80° C.

Colorant

One or more colorants can be used in combination with the above-mentioned colorants having formula (1), (2) or (3) in an amount of not greater than 20% by weight based on the total weight of the colorants included in the toner, for example, to adjust the color toner of the toner. Specific examples of such colorants include quinacridone, Watchung Red, PERMANENT RED, BRILLIANT CARMINE 3B, BRILLIANT CARMINE 6B, DUPONT OIL RED, Pyrazolone Red, LITHOL RED, RHODAMINE B LAKE, LAKE RED C, rose bengal, azo pigments, xanthene pigments, etc.

Charge Controlling Agent

The toner of the present invention optionally includes a charge controlling agent.

Suitable examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc. These materials can be used alone or in combination.

Specific examples of the marketed charge controlling agents include BONTRON® 03 (Nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® (triphenylmethane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, a quaternary ammonium group, etc.

Wax

As mentioned above, the present inventors discover that a wax dispersed in a polyester resin including an inorganic tin compound has an average particle diameter smaller than that of the wax dispersed in a polyester resin including an organic tin compound when the cross sections of the toners are observed with a transmission electron microscope (TEM). Therefore, the toner of the present invention has good releasability from a fixing roller in the fixing process. Since a wax, which has a lower molecular weight than a binder resin, is well dispersed in toner particles, the low temperature fixability of the toner can be further improved.

Waxes having a melting point of from 60 to 100° C. are preferably used for the toner. This is because the waxes dispersed in binder resins can produce good releasing effects when the toner particles in a toner image are heated at an interface between the toner image and a fixing member (such as fixing rollers), and thereby a hot offset problem can be avoided even when a release agent such as oils is not applied to the fixing roller.

Suitable waxes for use in the toner include carnauba waxes. Rice waxes and ester waxes can also be preferably used. Carnauba waxes are a natural wax which can be obtained from leaves of carnauba palm trees. Among various carnauba waxes, carnauba waxes which are subjected to a free fatty acid elimination treatment and which have a low acid value are preferably used because of easily and uniformly dispersed in binder resins. Rice waxes are also a natural wax which are prepared by refining crude waxes produced in a de-waxing process or a wintering process when refining a rice bran oil extruded from rice bran. Ester waxes can be produced by subjecting a mono-functional linear fatty acid and a mono-functional linear alcohol to an ester reaction. Other waxes such as polyolefin waxes such as polyethylene waxes and polypropylene waxes can also be used. These waxes can be used alone or in combination.

The added amount of a wax in the toner is preferably from 3to 8 parts by weight per 100 parts by weight of the toner particles. When the added amount is too small, a good releasability cannot be imparted to the resultant toner. In contrast, when the added amount of a wax is too large, the high temperature preservability of the toner deteriorates, and the filming problem in that the wax is adhered to a photoreceptor, resulting in formation of a wax film thereon tends to occur. The wax content is preferably from 4 to 6 parts by weight per 100 parts by weight of the toner particles.

Lubricant

It is preferable that the toner further includes a lubricant to improve the cleanability of the toner and to prevent occurrence of a filming problem in that the toner adheres to the surface of the photoreceptor. Specific examples of the lubricant include metal salts of fatty acids such as lead oleate, zinc oleate, copper oleate, zinc stearate, cobalt stearate, iron stearate, copper stearate, zinc palmitate, copper palmitate, and zinc linoleate. Among these materials, zinc stearate is preferably used. The lubricant is preferably added to mother toner particles which are prepared by melting/kneading toner constituents such as binder resins and colorants, and pulverizing the mixture after cooling.

When the toner includes a lubricant, the adhesion of toner particles to the surface of a photoreceptor can be decreased, and thereby toner particles remaining on the surface of a photoreceptor can be well removed with a cleaning blade. In addition, a filming problem in that the toner adheres to the surface of a photoreceptor (i.e., formation of a toner film on the surface) can be avoided.

The content of the lubricant in the toner is preferably from 0.01 to 1.0 parts by weight, and more preferably from 0.05 to 0.5 parts by weight, per 100 parts by weight of the toner particles. When the content is too low, the above-mentioned effects cannot be produced. In contrast, when the content is too high, the low temperature fixability of the toner deteriorates.

Particulate Inorganic Material (External Additive)

A particulate inorganic material is preferably included in the toner of the present invention as an external additive to improve the fluidity, developing properties and charging properties of the toner. The primary average particle diameter of such inorganic materials is preferably from 5 nm to 2 μm, and preferably from 5 nm to 500 nm. In addition, the specific surface area of such inorganic materials is preferably from 20 to 500 m²/g when measured by a BET method. The content of such inorganic materials in the toner is preferably from 0.01 to 5% by weight, and more preferably from 0.01 to 2.0% by weight, based on total weight of the toner.

Specific examples of the particulate inorganic materials include silica, alumina, titanium oxide, barium titanate, magnesium titanate, calcium titanate, strontium titanate, zinc oxide, tin oxide, quartz sand, clay, mica, sand lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Among these inorganic materials, a combination of silica and titanium oxide, both of which are preferably hydrophobized, is preferably used to improve the fluidity of the toner. Particularly, when a combination of a hydrophobized silica and a hydrophobized titanium oxide each having an average particle diameter of not greater than 50 nm is used, the electrostatic force and van der Waals force of the inorganic material with toner particles can be dramatically improved. Therefore, even when the toner is agitated in a developing device to impart a desired charge to the toner, the fluidizer (i.e., the combination of the inorganic materials) is not released from the toner particles, and thereby high quality images can be produced without forming undesired images such as white spots and the amount of residual toner particles can be reduced.

When a titanium oxide is used as a fluidizer, the resultant toner has good environmental stability and can stably produce high density images. However, the toner tends to have poor charge rising property. Therefore, the content of a titanium oxide is preferably not higher than that of a silica. When the content of a combination of a hydrophobized titanium oxide and a hydrophobized silica is from 0.3 to 1.5% by weight, the charge rising property of the resultant toner is not deteriorated and high quality images can be stably produced even when images are repeatedly produced for a long period of time.

Preparation of Toner

The method for preparing the toner for use in the image forming apparatus of the present invention is not particularly limited, and known manufacturing methods such as kneading/pulverizing methods and polymerizing methods can be used. The kneading/pulverizing methods typically include the following steps:
(1) toner constituents such as binder resins, waxes, colorants, charge controlling agents and other additives are mixed with a mixer;
(2) the mixture is kneaded with a kneader such as heat rollers and extruders, followed by cooling;
(3) the kneaded mixture is pulverized with a pulverizer such as jet mills; and
(4) the pulverized mixture is classified to prepare toner particles.

The thus prepared toner particles are then mixed with one or more of the particulate inorganic materials mentioned above using a mixer such as SUPER MIXER and HENSCEL MIXER.

The thus prepared toner preferably has a weight average particle diameter (D4) of from 3 to 10 μm. When the average particle diameter is too small, a problem in that toner particles adhere to the surface of a magnetic carrier included in a two component developer when agitated in a developing device for a long period of time, resulting in deterioration of charging ability of the carrier. When such a toner is used as a one component developer, a problem in that the toner adheres to a developing roller or a blade used for forming a thin toner layer on a developing roller tends to occur. In contrast, when the weight average particle diameter is too large, high quality and high definition images cannot be produced. In addition, the particle diameter of the toner tends to vary when used in a developing device for a long period of time while a fresh toner is replenished.

The toner of the present invention can be used as a one component developer by itself, and can be used for a two component developer by being combined with a magnetic carrier.

Known carriers for use in the conventional two component developers can be used for the developer of the present invention. Specific examples of the materials for use as the carrier include particles of magnetic materials such as iron and ferrites; resin-coated carriers in which particulate magnetic materials are covered with a resin; and particulate resin carriers in which a magnetic powder is dispersed in a particulate resin. Among these carriers, resin-coated carriers which are coated with a resin, such as silicone resins, copolymers (such as graft copolymers) of organopolysiloxanes and vinyl monomers, and polyester resins, for the covering resin can be preferably used because occurrence of a spent toner problem in that toner adheres to the surface of carrier particles, and thereby the charging ability of the carrier particles is deteriorated can be prevented. In addition, it is more preferable to use a carrier coated with a resin which is prepared by reacting a copolymer of organopolysiloxane and a vinyl monomer with an isocyanate, because the resultant carrier has a good combination of durability, weather resistance and resistance to the spent toner problem. In this case, it is necessary for the vinyl monomer to include a group reactive with an isocyanate, such as a hydroxyl group.

The magnetic carrier particles for use in the developer of the present invention preferably have a volume average particle diameter of from 20 to 100 μm, and more preferably from 20 to 60 μm, to produce high quality images and to prevent a problem in that background of toner images is soiled with toner due to the carrier particles used.

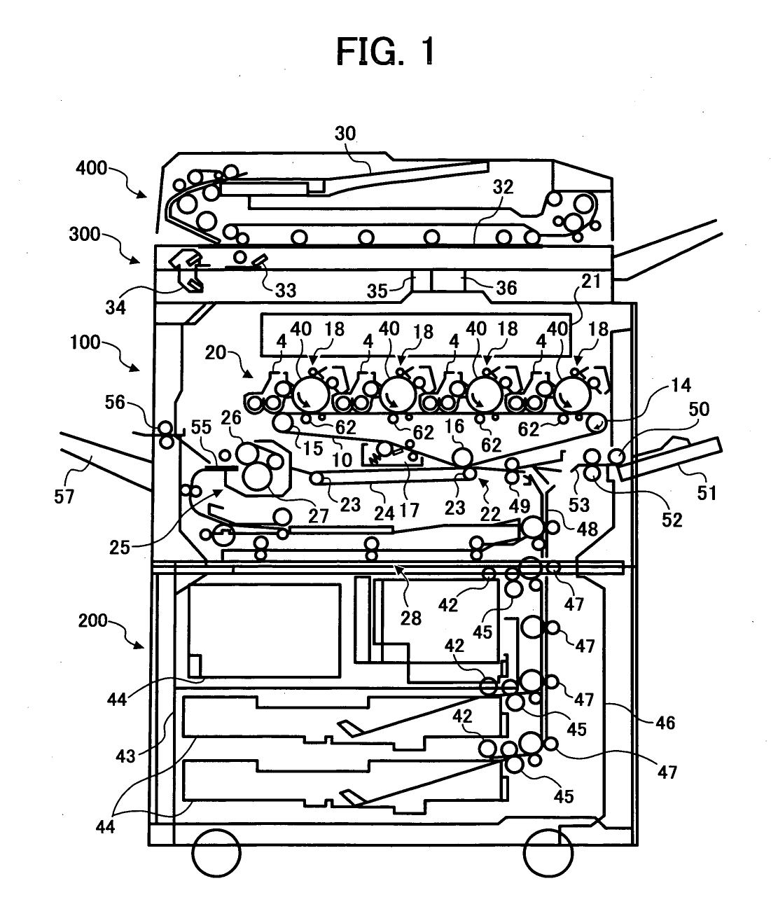

The image forming apparatus of the present invention will be explained referring to FIG. 1.

FIG. 1 is the overview of an embodiment of the image forming apparatus of the present invention, which is a tandem-type color image forming apparatus. In FIG. 1, the tandem-type color image forming apparatus includes a main body 100 of the image forming apparatus, a paper feeding section 200, a scanner 300 and an automatic document feeder (ADF) 400.

The main body 100 of the image forming apparatus includes a tandem-type image forming section 20 including four image forming units 18 which are arranged side by side to form different color images (such as yellow, magenta, cyan and black toner images) and each of which includes members for performing image forming processes such as charging, developing and cleaning. A light irradiator 21, which irradiates each of photoreceptors 40 serving as an image bearing member with imagewise light to form an electrostatic latent image on the photoreceptor, is arranged at a location over the image forming section 20. An endless intermediate transfer medium 10 is provided so as to face the photoreceptors 40 of the image forming section 20. A primary transfer device 62 (four transfer rollers 62 in FIG. 1) is arranged to transfer color toner images formed on the photoreceptors 40 to the intermediate transfer medium 10.

A second transfer device 22 is provided below the intermediate transfer medium 10. The second transfer device 22 includes an endless belt 24 which is rotatably stretched a pair of rollers 23. The endless belt 24 feeds a recording material fed from the feeding table 200 so that the toner images on the intermediate transfer medium 10 are transferred to the recording material while sandwiched by the intermediate transfer medium 10 and the endless belt 24.

A fixing device 25 is arranged at a position near the second transfer device 22. The fixing device 25 includes an endless fixing belt 26 and a pressing roller 27 which presses the fixing belt 26.

The second transfer device 22 also has a sheet feeding function of feeding recording paper sheets to the fixing device 25. It is also possible that the second transfer device 22 includes a transfer roller and a non-contact charger. In this case, the second transfer device cannot have a function of feeding recording paper sheets.

In addition, a sheet reversing device 28 configured to reverse the receiving material is provided at a position near the fixing device 25, to produce double-sided copies.

Each image forming unit 18 includes a developing device 4 which contains the toner (developer) mentioned above. The developing device 4 includes a developer bearing member configured to bear and feed the toner to a developing position at which the developer bearing member faces the photoreceptor 40. The developing device 4 develops an electrostatic latent image on the photoreceptor 40 with a developer including the toner mentioned above while applying an alternate voltage. By applying an alternate voltage to the developer, the developer is activated, and thereby the developer has a narrow charge quantity distribution, resulting in improvement of the developability of the developer.

A process cartridge including at least a photoreceptor and a developing device, which are integrated onto a unit and which can be detachably attached to the image forming apparatus, can also be used. The process cartridge can include other devices such as chargers and cleaners. By using such a process cartridge, the maintainability of the image forming apparatus can be improved because the image forming unit 18 can be easily replaced with new one.

Then the full color image forming operation using the tandem-type color image forming apparatus will be explained.

An original to be copied is set on an original table 30 of the automatic document feeder 400. Alternatively, the original is directly set on a glass plate 32 of the scanner 300 after the automatic document feeder 400 is opened, followed by closing of the automatic document feeder 400. When a start button (not shown) is pushed, the color image on the original on the glass plate 32 is scanned with a first traveler 33 and a second traveler 34 which move in the right direction. In the case where the original is set on the table 30 of the automatic document feeder 400, at first the original is fed to the glass plate 32, and then the color image thereon is scanned with the first and second travelers 33 and 34. The first traveler 33 irradiates the color image on the original with light and the second traveler 34 reflects the light reflected from the color image to send the color image light to a sensor 36 via a focusing lens 35. Thus, color image information (i.e., black, yellow, magenta and cyan color image data) of the original is read.

The black, yellow, magenta and cyan color image data are sent to the respective black, yellow, magenta and cyan color image forming units 18, and black, yellow, magenta and cyan color toner images are formed on the respective photoreceptors 40 by performing the charging, light irradiating and developing processes. Each of the image forming units 18 includes a charger configured to charge the image bearing member 40, the developing device 4, an image bearing member's cleaning device configured to clean the surface of the image bearing member.

The thus prepared black, yellow, magenta and cyan color toner images are transferred one by one to the intermediate transfer medium 10 which is rotated by rollers 14, 15 and 16, one of which is a driving roller and the other of which are driven rollers, resulting in formation of a full color toner image on the intermediate transfer medium 10.

On the other hand, one of paper feeding rollers 42 is selectively rotated to feed the uppermost paper sheet of paper sheets stacked in a paper cassette 44 in a paper bank 43 while the paper sheet is separated one by one by a separation roller 45 when plural paper sheets are continuously fed. The paper sheet is fed to a passage 48 in the main body 100 through a passage 46 in the paper feeding section 200, and is stopped once by a pair of registration rollers 49. Numeral 47 denotes feed rollers. A paper sheet can also be fed from a manual paper tray 51 to a passage 53 by a feed roller 50 and a pair of separation rollers 52. The thus fed paper sheet is also stopped once by the registration roller 49. The registration rollers 49 are generally grounded, but a bias can be applied thereto to remove paper dust therefrom.

The thus prepared full color toner image on the intermediate transfer medium 10 is transferred to the paper sheet, which is timely fed by the registration roller 49, at the contact point of the second transfer device 22 and the intermediate transfer medium 10. Toner particles remaining on the surface of the intermediate transfer medium 10 even after the second image transfer operation are removed therefrom by the cleaner 17.

The paper sheet having the full color toner image thereon is then fed by the second transfer device 22 to the fixing device 25, and the toner image is fixed on the paper sheet upon application of heat and pressure in the fixing device 25. Then the paper sheet is discharged from the main body 100 by a pair of discharge rollers 56 while the path is properly selected by a paper path changing pick 55. Thus, a copy is stacked on a tray 57.

When a double sided copy is produced, the paper sheet having a toner image on one side thereof is fed to the sheet reversing device 28 to be reversed. Then the paper sheet is fed to the second transfer device 24 so that an image is transferred to the other side of the paper sheet. The image is also fixed by the fixing device 25 and then the copy is discharged to the tray 57 by the discharge roller 56.

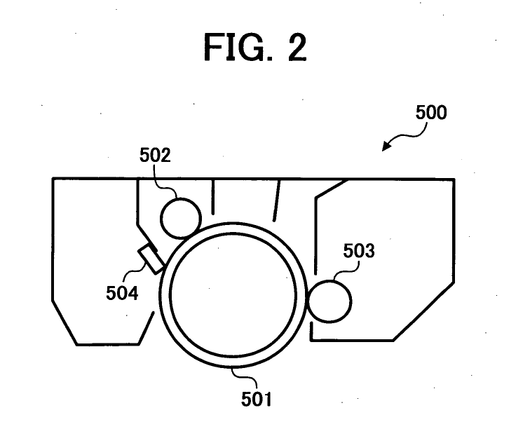

FIG. 2 is a schematic view illustrating an example of the process cartridge of the present invention. In FIG. 2, a process cartridge 500 includes a photoreceptor 501 serving as an image bearing member configured to bear an electrostatic latent image, a charger 502 configured to charge the photoreceptor 501, a developing device 503 configured to develop the electrostatic latent image with a developer including the toner mentioned above to form a toner image on the photoreceptor 501, and a cleaning device 504 configured to clean the surface of the photoreceptor 501 after the toner image is transferred. The photoreceptor 501, charger 502, developing device 503, and cleaning device 504 are unitized in the process cartridge. The process cartridge is detachably set in an image forming apparatus. The configuration of the process cartridge is not limited thereto, and the process cartridge of the present invention includes at least an image bearing member configured to bear an electrostatic latent image and a developing device configured to develop the electrostatic latent image with a developer including the tone mentioned above to form a toner image on the image bearing member.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Preparation of Polyester Resin (a)

(Preparation of Low Molecular Weight Polyester)

The following components were fed to a four neck glass flask equipped with a thermometer, a stirrer, a condenser and a nitrogen gas feed pipe.

| | |
|---|---|
| Polyoxypropylene(2.2)-2,2- | 390 g |
| bis(4-hydroxyphenyl)propane | |
| Isophthalic acid | 120 g |
| 1,2,5-benzenetricarboxylic acid | 38 g |
| Tin (II) dioctanate | 1 g |

Then the flask was set on a mantle heater. After nitrogen gas was fed into the flask so that the inside of the flask is in an inert gas environment, the components were heated at 220° C. under nitrogen gas flow to synthesis a polyester resin. The reaction was performed until the resultant polyester resin had a predetermined softening point. Thus, a polyester resin (a) was prepared.

It was confirmed that the resultant polyester resin (a) has a weight average molecular weight. (Mw) of 14,600, an acid value of 2.7 mgKOH/g and a glass transition temperature of 63° C.

Preparation of Polyester Resin (b)

(Preparation of High Molecular Weight Polyester Resin)

The procedure for preparation of the polyester resin (a) was repeated except that the reaction time was changed to prepare a polyester resin (b).

It was confirmed that the resultant polyester resin (a) has a weight average molecular weight (Mw) of 299,000, an acid value of 19.8 mgKOH/g and a glass transition temperature of 70° C.

Preparation of Toner

At first, the following components were mixed.

| | |
|---|---|
| Polyester resin (a) | 3 parts |
| Polyester resin (b) | 2 parts |
| Magenta color pigment | 5 parts |
| (Pigment Red 269) | |
| Pure water | 2.5 parts |

The mixture was kneaded at 70° C. using a two-roll mill. Then the temperature of the rollers of the roll mill was increased to 120° C. to evaporate water from the kneaded mixture. Thus, a magenta colorant master batch was prepared.

The following components were mixed.

| | |
|---|---|
| Magenta colorant master batch | 10 parts |
| Polyester resin (a) | 57 parts |
| Polyester resin (b) | 38 parts |
| Charge controlling agent | 2 parts |
| (BONTRON E-84 from Orient Chemical | |
| Industries Co., Ltd.) | |

The mixture was kneaded for 40 minutes at 50° C. (preset temperature) using the two-roll mill. Although the preset temperature was 50° C., the temperature of the kneaded mixture was not lower than about 120° C. due to self-heating of the materials. After being cooled, the kneaded mixture was crashed with a crasher, HAMMER MILL, followed by pulverization using an air jet pulverizer. The thus prepared magenta color powder was classified to prepare mother toper particles having a weight average particle diameter (D4) of 6.8 μm. The mother toner particles were mixed with 0.15 parts of zinc stearate (from Sakai Chemical Industry Co., Ltd., 1 part of a hydrophobized silica (from Clariant Japan K.K.) and 1 part of a hydrophobized titanium oxide (from Tayca Corp.) using a mixer. Thus, a toner (1) having a weight average particle diameter of 6.8 μm was prepared.

### Example 2

The procedure for preparation of the toner (1) was repeated except that the magenta color pigment was replaced with 5 parts of another magenta color pigment (PIGMENT RED 184, i.e., a mixture of PIGMENT RED 146 and PIGMENT RED 147). Thus a toner (2) having a weight average particle diameter of 6.8 μm was prepared.

### Comparative Example 1

The procedure for preparation of the toner (1) was repeated except that the magenta color pigment was replaced with 5 parts of a pigment (PIGMENT RED 122). Thus a toner (3) having a weight average particle diameter of 6.8 μm was prepared.

### Comparative Example 2

The procedure for preparation of the toner (1) was repeated except that the polyester resins (a) and (b) were replaced with polyester resins (c) and (d), which had been prepared by the same methods as mentioned above for use in preparing the polyester resins (a) and (b) in Example 1 except that tin (II) dioctanate was replaced with dibutyl tin oxide, respectively. Thus, a toner (4) having a weight average particle diameter of 6.8 μm was prepared.

It was confirmed that the polyester resin (c) has a weight average molecular weight (Mw) of 14,000, an acid value of 2.7 mgKOH/g and a glass transition temperature of 66° C., and the polyester resin (d) has a weight average molecular weight (Mw) of 301,000, an acid value of 19.8 mgKOH/g and a glass transition temperature of 71° C.

### Example 3

The procedure for preparation of the toner (1) was repeated except that 5 parts of a carnauba wax was added when the colorant master batch, polyester resins and charge controlling agent were mixed.

Thus, a toner (5) having a weight average particle diameter of 6.8 μm was prepared.

### Example 4

The procedure for preparation of the toner (1) was repeated except that 8.5 parts of a carnauba wax was added when the colorant master batch, polyester resins and charge controlling agent were mixed.

Thus, a toner (6) having a weight average particle diameter of 6.8 μm was prepared.

Each of the toners was evaluated as follows.

Image Quality

Each toner was mixed with a silicone-coated copper-zinc ferrite having an average particle diameter in a weight ratio of 5:95. Each of the thus prepared two-component developers was set in a copier (modified version of IMAGIO MF7070 manufactured by Ricoh Co., Ltd.), and a 100,000-copy running test was performed. Copies were produced at a rate of 5000 copies per day.

Before and after the running test, images were produced to evaluate the lowest fixable temperature, the highest fixable temperature and the toner scattering property of the toner. Evaluation methods are as follows.

(1) Lowest Fixable Temperature

Images were produced while the fixing temperature was changed. Each of the images was rubbed with a cloth and the image density of the rubbed image was measured. The property (lowest fixable temperature) was graded as follows.

Rank 5 (excellent) : Image density of the image fixed at 135° C. is not higher than 0.4 after rubbing.

Rank 4 (good): Image density of the image fixed at 140° C. is not higher than 0.4 after rubbing.

Rank 3 (acceptable) : Image density of the image fixed at 145° C. is not higher than 0.4 after rubbing.

Rank 2 (bad): Image density of the image fixed at 150° C. is not higher than 0.4 after rubbing.

Rank 1 (seriously bad) : Image density of the image fixed at 155° C. is not higher than 0.4 after rubbing.

(2) Highest Fixable Temperature

Images were produced while the fixing temperature was changed. The images were visually observed to determine whether a hot offset image is observed in the images. The property (highest fixable temperature) was graded as follows.

Rank 5 (excellent): A hot offset image is not formed at a fixing temperature not higher than 240° C.

Rank 4 (good) : A hot offset image is not formed at a fixing temperature not higher than 235° C.

Rank 3 (acceptable): A hot offset image is not formed at a fixing temperature not higher than 230° C.

Rank 2 (bad): A hot offset image is not formed at a fixing temperature not higher than 225° C.

Rank 1 (seriously bad): A hot offset image is not formed at a fixing temperature not higher than 220° C.

(3) Toner Scattering

After the running test, the developing device of the copier was observed to determine whether the developing device is contaminated with the toner. The property (toner scattering) was graded as follows.

Rank 5 (excellent): The entire developing device was not contaminated with toner particles.

Rank 4 (good): The entire developing device was hardly contaminated with toner particles.

Rank3 (acceptable) : The entire developing device was slightly contaminated with toner particles.

Rank 2 (bad) : The entire developing device was contaminated with a small amount of toner particles.

Rank 1 (seriously bad): The entire developing device was contaminated with a large amount of toner particles.

The evaluation results are shown in Table 1.

TABLE 1

| | Lowest fixable | Highest fixable | |
|---|---|---|---|
| | temperature | temperature | Toner scattering |
| Ex. 1 | 4 | 4 | 5 |
| Ex. 2 | 4 | 4 | 4 |
| Comp. | 4 | 4 | 2 |
| Ex. 1 | | | |
| Comp. | 3 | 3 | 5 |
| Ex. 2 | | | |
| Ex. 3 | 5 | 5 | 5 |
| Ex. 4 | 4 | 4 | 5 |

It is clear from Table 1 that the magenta toners of the present invention (i.e., the toners of Examples 1-4) hardly causes the toner scattering problem while having a good combination of low temperature fixability and high temperature fixability. In particular, the toner of Example 3, which includes a polyester resin including an inorganic tin compound; a naphthol pigment; and a wax, does not cause the toner scattering problem while having an excellent combination of low temperature fixability and high temperature fixability.

This document claims priority and contains subject matter related to Japanese Patent Application No. 2004-320116, filed on Nov. 04, 2004, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A magenta color toner comprising:
toner particles comprising:
a binder resin comprising a polyester resin including an inorganic tin (II) compound;
a colorant having a naphthol compound having a formula selected from the group consisting of the following formulae (1), (2) and (3):

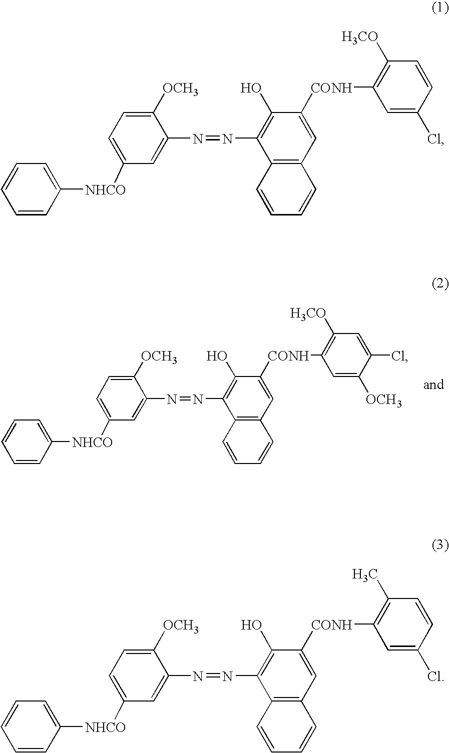

2. The magenta color toner according to claim 1, wherein the toner particles comprises a wax.

3. The magenta color toner according to claim 2, wherein the wax is a carnauba wax.

4. The magenta color toner according to claim 2, wherein the wax is included in the toner particles in an amount of from 3 to 8 parts by weight per 100 parts by weight of the toner particles.

5. The magenta color toner according to claim 1, wherein the inorganic tin (II) compound comprises one member selected from the group consisting of tin (II) dioctanate, tin (II) distearate and tin (II) oxide.

6. The magenta color toner according to claim 1, wherein the inorganic tin (II) compound is included in the toner particles in an amount of from 0.001 to 5 parts by weight per 100 parts by weight of the polyester resin.

7. The magenta color toner according to claim 1, wherein the polyester resin comprises a unit obtained from a polypropyleneoxide adduct of bisphenol A and a unit obtained from terephthalic acid.

8. The magenta color toner according to claim 1, further comprising:
an external additive which is present at least on a surface of the toner particles.

9. The magenta color toner according to claim 8, wherein the external additive comprises a particulate inorganic material.

10. The magenta color toner according to claim 9, wherein the particulate inorganic material comprises a hydrophobized silica and a hydrophobized titanium oxide.

11. A toner cartridge containing the magenta color toner according to claim 1.

12. A process cartridge comprising:
a photoreceptor bearing an electrostatic latent image on a surface thereof; and
a developing device configured to develop the electrostatic latent image with a developer including the magenta color toner according to claim 1 to form a toner image on the surface of the photoreceptor,
wherein the process cartridge is detachably attached to an image forming apparatus as a unit.

13. An image forming apparatus comprising:
a photoreceptor;
a charger configured to charge a surface of the photoreceptor;
a light irradiator configured to irradiate the charged photoreceptor with imagewise light to form an electrostatic latent image on the surface of the photoreceptor;
a developing device configured to develop the electrostatic latent image with a developer including the magenta color toner according to claim 1 to form a toner image on the surface of the photoreceptor; and
a transferring device configured to transfer the toner image onto a receiving material optionally via an intermediate transfer medium.
